(19) United States
(12) Patent Application Publication
(10) Pub. No.: US 2026/0292042 A1
(43) Pub. Date: Sep. 24, 2026

(54) METHOD AND A SYSTEM FOR HANDLING TIMEOUT IN BULK DATA REQUESTS

(71) Applicant: Honeywell International Inc., Charlotte, NC (US)

(72) Inventors: Sivasankari Shanmugham, Bangalore (IN); Madhuri Kalle, Bangalore (IN); Rahul Kumawat, Nawalgarh (IN)

(21) Appl. No.: 19/083,470

(22) Filed: Mar. 19, 2025

(51) Int. Cl. H04L 67/566; H04L 67/561

(52) U.S. Cl. CPC H04L 67/566; H04L 67/561

(57) ABSTRACT

The present disclosure discloses a method for managing timeouts for the bulk data requests by adjusting a timeout value provided by an Open Platform Communication Unified Architecture (OPC UA) client. In an embodiment, the timeouts for the bulk data request are managed by adjusting a timeout value such that the requested bulk data is received before the occurrence of a timeout. According to an embodiment, the OPC UA primary aggregator estimates a reduced timeout value by considering the connection architecture of the industrial network. The reduced timeout value is then reduced from a base timeout value provided by the OPC UA client to obtain a modified timeout value. As the data traverses through various OPC UA aggregators and data sources deployed at levels, the reduced timeout value is estimated such that there is a possibility of receiving the data before a timeout occurs at the OPC UA client.

### FIELD OF INVENTION

The present disclosure generally relates to a method for handling timeout in bulk data requests in a network. In particular, the present disclosure discloses a method for managing timeouts for the bulk data requests by adjusting a timeout value provided by an Open Platform Communication Unified Architecture (OPC UA) client.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In general, for analyzing the behavior, pattern, or trends in devices like sensors or actuators, bulk data is required from the end data sources (for example Historian). Accordingly, a client may request for history data in bulk from bulk nodes in a single request. For example, the client may raise a single request (i.e. a bulk data request) for 100 nodes of data points to the bulk nodes. In a multi-level connection architecture of an industrial network, generally, an Open Platform Communication Unified Architecture (OPC UA) client sends the bulk data request to one or more OPC UA aggregators which is further redirected to end data sources, where the one or more OPC UA aggregators and the end data sources are deployed at various levels. In such a scenario, the OPC UA client directly coupled and interacts with a primary OPC UA aggregator. Further, the primary OPC UA aggregator is directly coupled and interacts with one or more direct end data sources. Furthermore, the primary OPC UA aggregator indirectly coupled and interacts with the one or more indirect end data sources via secondary OPC UA aggregators.

Now, in such a multi-level connection architecture, during the data traversal of the bulk data request, there is a possibility of frequent request timeouts as the timeout between the OPC UA client and the primary OPC UA aggregator is less than the request timeout between the primary OPC UA aggregators, secondary OPC UA aggregators and the end data sources. Due to this, there is a possible data loss. This is bound to happen in networks where there are many sensors deployed at one level, OPC UA aggregators are deployed at the next level and the end data sources are deployed as a chain of data sources at the same levels as that of the OPC UA aggregators or in the next levels.

FIG. 1 shows an example scenario of an occurrence of a timeout in a multi-level connection architecture. Consider an example scenario where the OPC UA client 101, the primary OPCUA aggregator 103, the secondary OPC UA aggregators 105, and end data sources 107 are operatively coupled with each other. According to the example scenario, the timeout between the OPC UA client 101 and the primary OPC UA aggregator 103 is less than the request timeout between the primary OPC UA aggregator 103, the secondary OPC UA aggregators 105, and the end data sources 107.

According to the example scenario, shown in FIG. 1, consider that the OPC UA client 101 sends the bulk data request along with a base timeout value of x=60 seconds to the primary OPC UA aggregator 103. Further, consider that a default timeout value of the primary OPC UA aggregator 103 and the secondary OPC UA aggregator 105 is y=80 seconds. Accordingly, the timeout set for receiving the data from the end data sources 107 is 80 seconds which is more than the timeout set by the OPC UA client 101. Therefore, the data received at the primary OPC UA aggregator 105 will be within 80 seconds. However, till then the timeout will occur for the primary OPC UA aggregator 103 for sending the received data. Thus, there is a potential data loss.

Thus, there is a need to provide a method for handling timeouts in the bulk data requests.

Through applied effort, ingenuity, and innovation, the inventors have solved and proposed the above problem(s) by developing the solutions embodied in the present disclosure, the details of which are described further herein.

### SUMMARY OF THE INVENTION

In general, embodiments of the present disclosure herein provide method for a managing timeouts for a bulk data request in a network. Other implementations will be or will become, apparent to one with skill in the art upon examination of the following figures and detailed description. It is intended that all such additional implementations be included within this description within the scope of the disclosure.

The present disclosure provides a method for managing timeouts for a bulk data request. According to an embodiment, the method includes receiving, from an Open Platform Communication Unified Architecture (OPC UA) client, the bulk data request along with a base timeout value. Further, the method includes determining a connection architecture of one or more direct data sources coupled to a primary OPC UA aggregator, and one or more indirect data sources coupled to the primary OPC UA aggregator via one or more secondary OPC UA aggregators, wherein the one or more direct data sources and the one or more indirect data sources provide data associated with the bulk data request. Further, the method includes applying, based on the connection architecture, a reduced timeout value on the base timeout value by the primary OPC UA aggregator and each of the one or more secondary OPC UA aggregators for obtaining the data. Further, the method includes sending the bulk data request along with the reduced timeout value to each of the one or more direct data sources, and the one or more secondary OPC UA aggregators connected with the one or more indirect data sources for receiving the data.

According to some embodiment, a system for managing timeouts for a bulk data request is disclosed. The system comprises a primary Open Platform Communication Unified Architecture (OPC UA) aggregator having one or more processors coupled with a memory, one or more direct data sources coupled with the primary OPC UA aggregator; one or more indirect data sources coupled with the primary OPC UA aggregator via one or more secondary OPC UA aggregators, and an OPC UA client coupled with the primary OPC UA aggregator. In an embodiment, the one or more processors are configured to receive, from the OPC UA client, the bulk data request along with a base timeout value. Further, the one or more processors are configured to determine a connection architecture of the one or more direct data sources, and the one or more indirect data sources, wherein the one or more direct data sources and the one or more indirect data sources provide data associated with the bulk data request. Further, the one or more processors are configured to apply, based on the connection architecture, a reduced timeout value on the base timeout value by the primary OPC UA aggregator and each of the one or more secondary OPC UA aggregators for obtaining the data. Further, the one or more processors are configured to send the bulk data request along with the reduced timeout value to each of the one or more direct data sources, and the one or more secondary OPC UA aggregators connected with the one or more indirect data sources for receiving the data.

According to some embodiment, a non-transitory computer-readable storage medium storing program instructions for managing timeouts for a bulk data request is disclosed. The program instructions when executed, perform the steps of receiving, from an Open Platform Communication Unified Architecture (OPC UA) client, the bulk data request along with a base timeout value. Further, the non-transitory computer-readable storage medium performs the step of determining a connection architecture of one or more direct data sources coupled to a primary OPC UA aggregator, and one or more indirect data sources coupled to the primary OPC UA aggregator via one or more secondary OPC UA aggregators, wherein the one or more direct data sources and the one or more indirect data sources provides data associated with the bulk data request. Further, the non-transitory computer-readable storage medium performs the step of applying, based on the connection architecture, a reduced timeout value on the base timeout value by the primary OPC UA aggregator and each of the one or more secondary OPC UA aggregators for obtaining the data. Further, the non-transitory computer-readable storage medium performs the step of sending the bulk data request along with the reduced timeout value to each of the one or more direct data sources, and the one or more secondary OPC UA aggregators connected with the one or more indirect data sources for receiving the data.

The above summary is provided merely for the purpose of summarizing some exemplary embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### DESCRIPTION OF THE DRAWINGS

Having thus described the embodiments of the disclosure in general terms, reference now will be made to the accompanying drawings, which are not necessarily drawn to scale, and wherein:

FIG. 1 illustrates an example scenario of an occurrence of a timeout in a multi-level connection architecture;

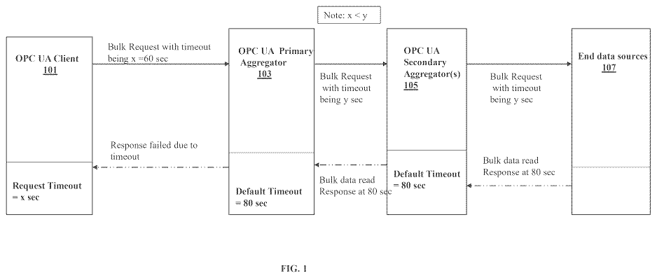

FIG. 2 illustrates an example of a system deployed with a multi-level connection architecture, according to an embodiment of the present disclosure;

FIG. 3 illustrates a simplified representation of the system of FIG. 2, according to an embodiment of the present disclosure;

FIG. 4 illustrates a detailed block diagram of the OPC UA primary aggregator, according to an embodiment of the present disclosure;

FIG. 5 depicts an example scenario for addressing the bulk request by a primary aggregator in a multi-level connection architecture, according to an embodiment of the present disclosure;

FIG. 6 illustrates an example embodiment of estimating the reduced timeout value using ML models, according to an embodiment of the present disclosure;

FIG. 7 illustrates another example scenario for estimating the reduced timeout value, according to an embodiment of the present disclosure;

FIG. 8 illustrates a method flow for managing timeouts for a bulk data request, according to an embodiment of the present disclosure; and

FIG. 9 illustrates a general block diagram of the system, according to an embodiment of the present disclosure.

### DESCRIPTION OF THE INVENTION

The description set forth below in connection with the appended drawings is intended as a description of various embodiments of the present invention and is not intended to represent the only embodiments in which the present invention may be practiced. Each embodiment described in this invention is provided merely as an example or illustration of the present invention, and should not necessarily be construed as preferred or advantageous over other embodiments. The description includes specific details for the purpose of providing a thorough understanding of the present invention. However, it will be apparent to those skilled in the art that the present invention may be practiced without these specific details. Further, the reference numerals for similar components, modules, units, and operation steps have been kept same for the ease of understanding.

Some embodiments of the present disclosure now will be described with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements.

According to an embodiment, a methodology for managing timeouts for a bulk data request in a network is disclosed. In an embodiment, the timeouts for the bulk data request are managed by adjusting a timeout value provided by an OPC UA client such that the requested bulk data is received before the occurrence of a timeout. According to an embodiment, the OPC UA primary aggregator estimates a reduced timeout value by considering the connection architecture of the industrial network. The reduced timeout value is then reduced from a base timeout value provided by the OPC UA client to obtain a modified timeout value. As the data traverses through various OPC UA aggregators and data sources deployed at levels, the reduced timeout value is estimated such that there is a possibility of receiving the data before a timeout occurs at the OPC UA client. A detailed explanation of the methodology will be explained in the forthcoming paragraphs.

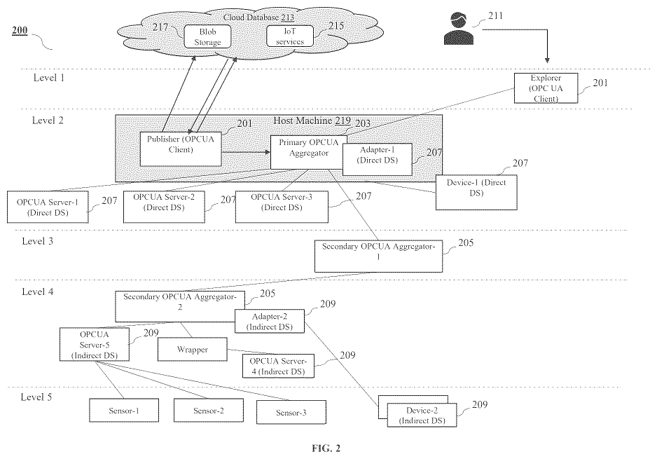

FIG. 2 illustrates an example of a system deployed with a multi-level connection architecture, according to an embodiment of the present disclosure. The example depicted here is the multi-level connection architecture in the case of an industrial network environment. In complex industrial environments, efficient data management and communication are critical for optimizing operations and ensuring safety. The multi-level connection architecture, generally uses an OLE for process Control (OPC) architecture or an Open Platform Communications Unified Architecture (OPC UA) that can seamlessly facilitate data exchange among various devices and systems. In the example depicted in FIG. 2, the multi-level connection architecture is deployed using the OPC unified architecture.

In an embodiment, a system 200 is deployed in the multi-level connection architecture that includes an OPC UA client 201, a primary OPC UA aggregator 203, one or more OPC UA secondary aggregators 205, and one or more OPC data sources deployed at various levels. The OPC data sources can be direct data sources 207 and indirect data sources 209. In an embodiment, these components work together to acquire and manage data from various sensors and devices deployed at various levels. Further, the ‘OPC UA client’ can be interchangeably referred to as ‘client’. The ‘primary OPC UA aggregator’ can be interchangeably referred to as ‘primary aggregator’. The ‘secondary OPC UA aggregator’ can be interchangeably referred to as ‘secondary aggregator’. Further, the ‘OPC data sources’ can be interchangeably referred to as ‘data sources’.

In a non-limiting example, the client 201 includes an explorer, a publisher. Further, the explorer and the publisher can be collectively labeled as 201. According to some embodiment, the client 201 may be deployed in level 1 of the industrial network.

In a further non-limiting example, the secondary aggregators may include a secondary OPC UA aggregator-1 and a secondary OPC UA aggregator-2. In an embodiment, the secondary aggregators may be collectively labeled as 205. As can be seen, the secondary OPC UA aggregator-1 and the secondary OPC UA aggregator-2 are deployed in level 3 and level 4.

In a further non-limiting example, the primary aggregator 203 is directly coupled with one or more direct data sources (DS). As an example, the direct DS includes an OPC UA server-1, OPC UA server-2, OPC UA server-3, Device 1, adapter 1. The direct DS may be collectively labeled as 207. Further, the primary aggregator 203 is indirectly coupled with one or more indirect DS. As an example, the indirect DS includes OPC UA server-4, OPC UA server-5, Device 2, adapter 2. As can be seen, the primary aggregator 203 is indirectly coupled with one or more indirect DS through the one or more secondary aggregators 205. The indirect DS may be collectively labeled as 209. The direct data source and the indirect data source may be collectively referred to as data source.

In an embodiment, the client 201 acts as a dashboard operated by manager 211. The client 201 coupled with the primary aggregator 203 to visualize key performance metrics, receive alerts about anomalies, and make data-driven decisions regarding production processes. The client 201 facilitates user interaction with aggregated data received from the end data sources. The manager 211 can view real-time dashboards displaying critical metrics or data such as production speed, downtime, quality control parameters, and behavioral parameters. Depending on the data insights, informed decisions, such as reallocating resources or adjusting machine parameters can be taken. Further, if a machine exhibits unexpected behavior, alerts can be quickly generated and sent to plant operators for immediate action.

In an embodiment, the explorer 201 is a client application used primarily for browsing, discovering, and interacting with OPC UA servers. The explorer 201 provides a graphical user interface to visualize the structure and contents of an OPC UA node address space. The explorer 201 is commonly used by developers, integrators, and engineers to configure systems, troubleshoot issues, and ensure proper connectivity and functionality of the OPC UA servers. As an example, the explorer 201 performs the following functions:
Browsing: Allows users to navigate through the hierarchical structure or the connection architecture of nodes (objects, variables, methods, etc.) exposed by the OPC UA server.
Reading Data: Enables users to read the values of variables and properties from the OPC UA server, providing insights into real-time data and states of devices.
Writing Data: Some explorers allow users to write values to variables, which is useful for modifying parameters or triggering actions on certain devices.
Subscribing to Events: Users can subscribe to events and notifications published by the server, which is useful for monitoring changes in data or receiving alerts.
Testing Communication: The explorers are often used as diagnostic tools to test various functionalities of a system.

In an embodiment, the publisher 201 is a client that is responsible for sending data updates to one or more subscribers, either over the OPC UA protocol or through another data distribution mechanism. The publisher efficiently communicates the critical real-time data to multiple clients or systems. As an example, the publisher may perform the following functions:
Publishing Data: The publisher continuously monitors specific data points (variables) and sends updates to all interested subscribers when values change or on a predefined schedule. This mechanism is especially useful for real-time data monitoring.
Data Aggregation: It may aggregate data from multiple sources or sensors before publishing, optimizing the flow of information and reducing network traffic.
Configuration: The publisher can typically be configured to determine which data points to publish, the frequency of updates, and the conditions under which updates are sent.
Support for Events: The publisher further handles event notifications informing subscribers of significant changes or occurrences within the system.

According to an embodiment, the primary aggregator 203 is deployed in a host machine 219. As an example, the host machine 219 is a virtual machine. In an embodiment, the primary aggregator 203 serves as the central data management hub. As depicted in FIG. 2, the primary aggregator 203 is deployed in level 2 of the industrial network. Further, the primary aggregator 203 is coupled with one or more secondary aggregators 205 deployed in levels 3 and 4 and centralizes the data collection process. The primary aggregator 203 and the secondary aggregators 205 form a daisy chain-like structure to pass the data to the client 101. The primary aggregators 203 perform a high-level aggregation, and data normalization, and ensure secure communication. As an example, the primary aggregator 203 collects and processes data from multiple secondary aggregators 205, consolidating the data from various units of the industrial network. In particular, the primary aggregator 203 retrieves processed data from all secondary aggregators 205 across all the units of the industrial network. As an example, the primary aggregator 203 performs further analysis, aggregating information on overall line efficiency, error rates, and equipment status. For instance, if multiple secondary aggregators report similar anomalies, the primary aggregator 203 consolidates this data to provide a comprehensive overview to the OPC UA client 201. According to some embodiment, the primary aggregators 203 can also trigger alerts when specific KPIs (Key Performance Indicators) are not met.

According to a further embodiment, the secondary aggregators 205 collect data from local sensors, actuators, adaptors, or any devices. The secondary aggregators 205 operate at a more granular level, such as within specific departments or equipment clusters, managing local data and communicating the same to the primary aggregator 203. Accordingly, the secondary aggregators 205 facilitate localized data processing, thereby receiving input from numerous sources and reducing the data load sent to the primary aggregator 203. For example, the secondary aggregators 205 collect data from sensors monitoring parameters like temperature, humidity, and pressure. According to some embodiment, the secondary aggregators 205 preprocess the collected data to reduce redundancy and deliver essential information to the primary aggregator 203, minimizing data transfer load.

According to an embodiment, the direct data sources 207 are the data sources that provide various data collected from various sources directly to the primary aggregator 203. For example, the direct data sources 207 include OPCUA server-1, OPC UA server-2, OPC UA server 3, adapter-1, device-1. As an example, the OPCUA server-1, OPC UA server-2, and OPC UA server 3 are capable of providing real-time data as well as historian data. The OPC UA servers collect, stores, and retrieve time-series data from various sources such as sensors, instrumentation, and systems in industrial and manufacturing environments. Data historians are important in industries like manufacturing, energy, utilities, and others for tracking operational performance, analyzing trends, and making informed decisions based on historical data. According to an embodiment, the indirect data sources 209 are the data sources that provide various data collated from various sources indirectly to the primary aggregator 203. For example, the indirect data sources 207 include OPCUA server-4, OPC UA server-5, adapter-2, device-2. In an embodiment, the indirect data sources 209 provides the data through the secondary aggregators 205 to the primary aggregators 203. As can be seen, sensor-1, sensor-2, and sensor-3 are deployed in level 5. Thus, the sensor data from the sensor-1, sensor-2, and sensor-3 are collected by the OPC UA server-5 which is collected by the secondary OPC UA aggregator-2 deployed at level 4. The sensor data is further provided to the secondary OPC UA aggregator-1 deployed at level 3. Further, the secondary OPC UA aggregator-1 provides the sensor data to primary aggregator 203.

In an embodiment, the information about the connection architecture of the system 200 will be stored at the OPC UA client 201. In an embodiment, all the data received by the OPC UA client 201 is then stored in a cloud database 213. In a non-limiting example, the cloud database 213 includes a database for IOT services 215 and a blob storage 217 for storing data.

When the client 201 sends a bulk request for historical data that includes a large amount of data points (for example, 100 nodes of data), the request needs to traverse through the entire multi-level connection architecture. This can lead to timing issues between the various components involved. For example, consider a scenario, where the OPC UA client 201 sends the bulk request to the OPC UA primary aggregator 203 for historical data on 100 nodes (sensors) simultaneously. Further, consider that the OPC UA client 201 has a base timeout setting of 5 seconds for waiting for a response from the OPC UA primary aggregator 203. The OPC UA primary aggregator 203, on the other hand, has a longer timeout setting of 15 seconds for its own requests to the end data sources. Thus, upon receiving the request, the OPC UA primary aggregator 203 breaks it down to request historical data for each of the 100 nodes from the end data source. In general, the primary aggregator 203 starts requesting the data from these nodes one by one or in small batches via secondary aggregators 205. If the response from a certain node takes longer than 5 seconds (the base timeout set for the OPC UA client 201), the OPC UA client 201 may timeout and assume that the request has failed. If the OPC UA client does timeout, it will not get the data it requested for the 100 nodes, and therefore, some of the data could be considered lost, even though the OPC UA aggregators are still actively trying to retrieve it. Therefore, the client 201 does not receive the complete set of data it originally requested. Thus, in order to overcome the above problem, the OPC UA primary aggregator reduces the base time timeout value by a reduced timeout value estimated by considering the connection architecture of the industrial network. In the multi-level architecture, each aggregators and end data sources may introduce a specific delay as they gather, process, and forward requests. Additionally, there are inherent network latency and processing times that may occur during data traversal through the system 200.

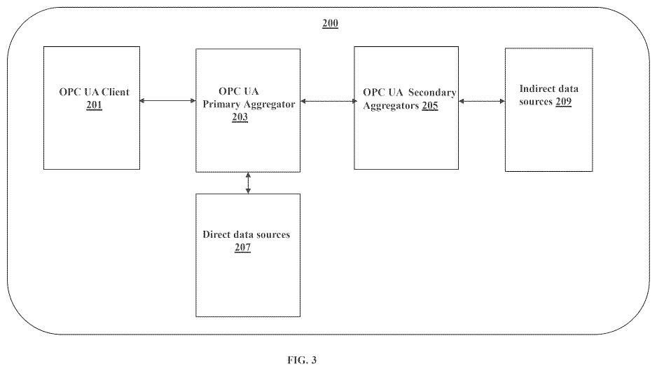

FIG. 3 illustrates a simplified representation of the system 200 of FIG. 2, according to an embodiment of the present disclosure. The reference numerals for the similar components, operations or functional steps have been kept same throughout the disclosure for the ease of understanding. According to an embodiment, the OPC UA client 201, OPC UA primary aggregator 203, and the OPC UA secondary aggregators typically include the following components:
A processing unit configured to handle multiple data streams, manage connections to various OPC UA servers, process & analyze the data, and run aggregation logic. This could be a dedicated industrial PC or a server comprising one or more processors.
A memory configured to cache data, run the OPC UA services, execute applications, manage OPC UA servers, manage communication processes efficiently, storing client applications, configuration files, and data or logs. The amount of RAM required depends on the volume of data being aggregated.
Network Interface configured to connect to the OPC UA servers and end data sources over wired network connections or wireless network interfaces.
Input/Output modules coupled with user interface applications, sensor devices, PLCs, and the like.

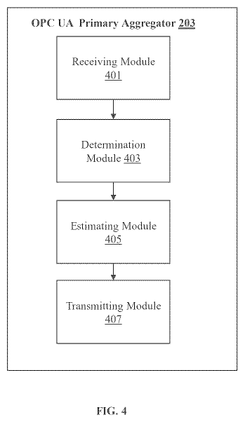

FIG. 4 illustrates a detailed block diagram of the OPC UA primary aggregator, according to an embodiment of the present disclosure. According to an embodiment, the OPC UA primary aggregator 203 is configured to manage timeouts for the bulk data request for the multilevel architecture as shown in FIG. 2. In an embodiment, the OPC UA primary aggregator 203 comprises a receiving module 401, a determination module 403, an estimation module 405, and a transmitting module 407 operatively coupled with each other. According to some embodiment, functions of the receiving module 401, the determination module 403, the estimation module 405, and the transmitting module 407 may be performed by one or more processors. However, for ease of understanding the explanation will be provided by referring to the modules as mentioned above. The functioning of the OPC UA primary aggregator 203 will be explained by referring to FIGS. 2-3, 5-8.

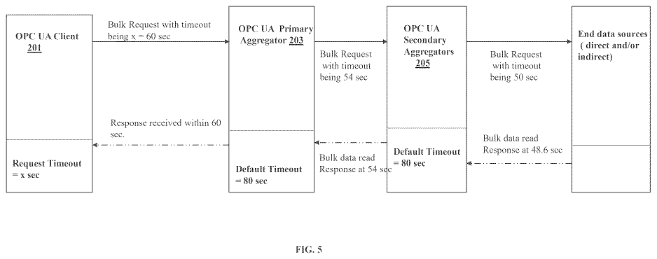

According to an embodiment, consider that the OPC UA client 201 raises a bulk request to a bulk number of nodes. FIG. 5 depicts an example scenario for addressing the bulk request by a primary aggregator in a multi-level connection architecture, according to an embodiment of the present disclosure. Consider that the OPC UA client 201 sends the bulk data request along with the base timeout value of x=60 seconds to the primary OPC UA aggregator 203. According to an embodiment, the receiving module 401 receives the bulk data request from the OPC UA client 201. In an embodiment, the OPC UA client 201 sends the bulk data request along with a base timeout value. In general, every aggregator in the network is configured with a default timeout value. For example, as depicted in the example scenario the primary OPC UA aggregator 203 is configured with the default timeout value as 80 sec. Thus, if the primary OPC UA aggregator 203 forwarded the bulk request with its set default timeout value (i.e. 80 sec) then there will be an occurrence of the timeout. Therefore, in order to manage the timeout, the primary OPC UA aggregator 203 estimates a reduced timeout value by considering the connection architecture of the industrial network. As explained in FIG. 2, the connection architecture provides information about a number of direct data sources, a number of indirect data sources, and a number of secondary OPC UA aggregators required to provide the data. The connection architecture further provides information about a deployment level of the one or more direct data sources, the one or more indirect data sources, and the one or more secondary OPC UA aggregators.

Accordingly, in an embodiment, the determination module 403 determines the connection architecture of one or more direct data sources 207 coupled to the primary OPC UA aggregator 203, and one or more indirect data sources 209 coupled to the primary OPC UA aggregator 203 via the secondary OPC UA aggregators 205. The one or more direct data sources 207 and the one or more indirect data sources 209 provide data associated with the bulk data request. In particular, the determination module 403 fetches the details the connection architecture from the OPC UA client 201 for example the explorer. The determination module 403 further analyses the bulk request. Accordingly, the determination module 403, based on the details of the connection architecture and the analysis of the bulk request, determines at least one of a number of direct data sources, a number of indirect data sources, and a number of secondary OPC UA aggregators required in providing the data. Further, the determination module 403 determines a deployment level of the one or more direct data sources, the one or more indirect data sources, and the one or more secondary OPC UA aggregators.

For example, in case the bulk data request includes a request to fetch the data from the sensor-1, the sensor-2, the device-2 along with other data sources then in that case, the data when sent by the aforesaid data sources shall traverse through various levels and through various number of secondary aggregators deployed at different levels. In an embodiment, the information provided by the connection architecture influenced the estimation of the reduced timeout value. For example, by determining the deployment level of the one or more direct data sources, the one or more indirect data sources, and the one or more secondary OPC UA aggregators, the estimation module 405 estimates parameters such as a network latency that indicate the time required for a request to travel from the OPC UA client 201 to the OPC UA secondary aggregators 205 and vice versa; a response time that indicates the time required for the data sources or secondary aggregators to process the bulk requests and respond it; load conditions that indicate current load conditions on the OPC UA secondary aggregators 205 and data sources that can affect response times; a data processing time that indicates the time required for the secondary aggregator 205 to process and transform the incoming request before sending it to the data source and receiving a response and the like.

According to an embodiment, based on the connection architecture, the estimation module 405 estimates the reduced timeout value to be applied on the base timeout value so that requested data can be received before the occurrence of the timeout at the client 201. According to some embodiments, the estimation module 405 may utilize ML models, or iterative methods for estimating the reduced timeout value.

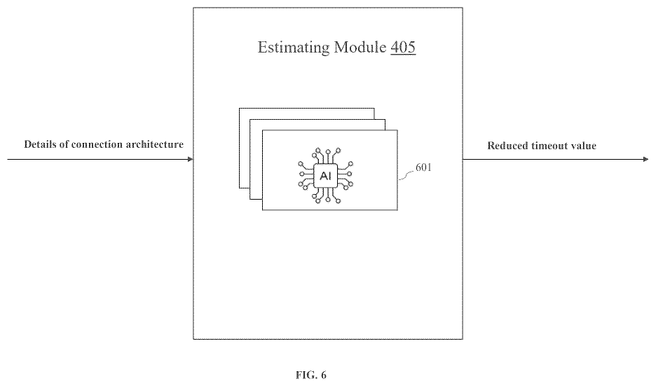

FIG. 6 illustrates an example embodiment of estimating the reduced timeout value using ML models, according to an embodiment of the present disclosure. In an embodiment, the estimation module 405 may be deployed with machine learning (ML) models 601 as shown in FIG. 6. According to an exemplary embodiment, the details of the connection architecture are provided as an input to the ML models 601. The ML model further processes the details of the connection architecture. In an embodiment, the estimation module 405 may further estimate the parameters such as network latencies, the response time, the load conditions, and the data processing time to estimate the reduced timeout value.

According to some embodiment, the estimation module 405 utilizes an iterative method or an optimization method for estimating the reduced timeout value. The iterative method may include, an initial guess. Further, the initial guess is refined through repeated applications of a specific algorithm or formula, until a certain level of accuracy is achieved or until the changes between iterations become negligible. For example, a certain initial value is considered as the reduced value. Further, the initial value is repeatedly refined till a specific value is obtained. In an embodiment, the reduced value is estimated such that when applied across the secondary aggregators, there is a possibility of receiving the data before a timeout occurs at the OPC UA client 201.

According to an embodiment, the estimation module 405, applies the reduced timeout value on the base timeout value and each of the one or more secondary OPC UA aggregators 205 for obtaining the data. In an embodiment, the estimation module 405 applies the reduced timeout value on the base timeout value by decreasing the reduced timeout value from the base timeout value. In an embodiment, the result of decreasing the reduced timeout value from the base timeout value provides a modified timeout value.

According to an embodiment, based on the connection architecture, the estimation module 405 further determines whether the data associated with the bulk data request can be received within the modified timeout value before implementing the reduced timeout value on the base timeout value. If the estimation module 405 determines that the data associated with the bulk data request cannot be received within the modified timeout value, then the estimation module 405 varies the reduced timeout value such that the data is received before the timeout occurs at the OPC UA client 201. According to some embodiment, the estimation module 405 may use the iterative method or the optimization method to vary the reduced timeout value in order to obtain an appropriate reduced timeout value. Accordingly, the estimating module 405 impalements the final reduced timeout value on the base timeout value to obtain the modified timeout value.

Alternatively, the estimation module 405 upon determining that the data associated with the bulk data request can be received within the modified timeout value, the estimation module 405 applies the reduced timeout value on the base timeout value. Mathematically, the modified timeout value can be represented by equation (1).

$${T}_{modified\_value} = {T}_{base t imeout\_value} - {T}_{reduced timeout\_value} \qquad ( 1 )$$

Where, the T_{reduced timeout_value} is f (x),
Where the f (x) is a function that depends on a connection architecture and base timeout value.

Consider the example scenario of FIG. 5, where the base timeout value is taken as x=60 seconds. Further, consider that the estimation module 405 estimates the reduced timeout value as 10% based on the connection architecture. In an embodiment, the 10% value will be reduced from the base timeout value to get the modified timeout value. Accordingly, the reduced timeout value is obtained as 6 seconds i.e. 10% of 60 seconds. In an embodiment, the primary OPC UA aggregator 203 then applies the reduced timeout value on the base timeout value, to obtain a modified timeout value. Accordingly, the modified timeout value for the primary OPC UA aggregator 203 is obtained as 60−6=54 seconds (i.e. T_{modified_value}).

In an embodiment, the transmitting module 409 sends the bulk data request along with the reduced timeout value to each of the direct data sources 207, the secondary aggregators 205 connected with the indirect data sources 209 for receiving the data. In particular, the transmitting module 409 forwards the bulk data request along with the reduced timeout value to the secondary OPC UA aggregators 205, the direct data sources 207, and the indirect data sources 209. In an embodiment, as the bulk data request is received by the secondary aggregators 205, the secondary OPC UA aggregators set a respective modified timeout value based on the reduced timeout value such that the respective modified timeout value is less than a previously received modified timeout value and the base timeout value.

Considering the same example, the scenario of FIG. 5. The primary OPC UA aggregator 203 forwards the bulk request to the secondary OPC UA aggregator 205 along with the 54 second timeout value. According to an example embodiment, the secondary aggregator 205 then set its respective timeout value based on the reduced timeout value as 48.6 seconds which is 10% of 54 seconds. Accordingly, the secondary aggregator 205 then forwards the bulk data request to the end data sources with the modified timeout value as 48.6 seconds. Thus, the bulk data request traverses to the end data sources along with the modified timeout value of 48.6 seconds.

According to an embodiment, when the secondary aggregators 205 perform a bulk data read operation from the end data sources, the end data sources shall send the bulk data read response within the modified timeout value as specified by the secondary aggregator while forwarding the bulk data request. This prevents data loss between OPC UA Aggregator and OPC UA Client as the timeout is adjusted and modified by the OPC UA aggregators in accordance with the base timeout value.

Considering the same example scenario of FIG. 5, as can be seen, though the default timeout values of the primary aggregators and the second aggregators are set as 80 seconds, the bulk data read response i.e. the response received by the secondary aggregators 205 is 48.6 seconds. Similarly, the bulk data read response i.e. the response received by the primary aggregator 203 is 54 seconds. Thus, the additional time that is left can be utilized to process and forward the data.

According to some embodiment, the estimation module 405 of FIG. 4 may be deployed outside the primary aggregator 203. For example, the estimation module 405 may be deployed in the cloud 213 or in the host machine 219. In such a scenario, the primary aggregator 203 receives the estimated reduced timeout value from the estimation module 405 deployed outside.

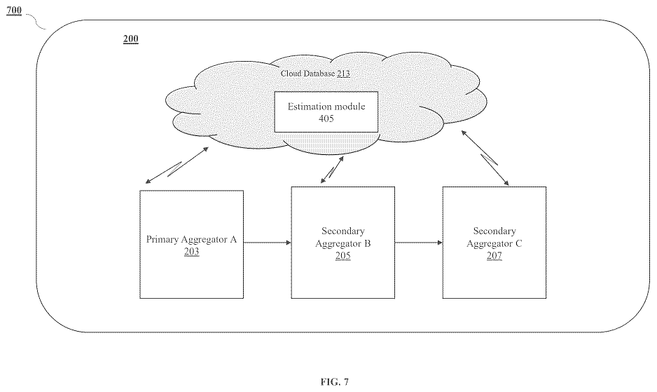

FIG. 7 illustrates another example scenario for estimating the reduced timeout value, according to an embodiment of the present disclosure. According to an example scenario 700, the estimation module 405 is deployed in the cloud 213. Further, a primary aggregator A 203, a secondary aggregator B 205, and a secondary aggregator C are coupled with each other in a daisy chain. Further, the primary aggregator A 203, the secondary aggregator B 205, and the secondary aggregator C are coupled with the estimation module 405. In the exemplary scenario, the rest of the components are not shown for the sake of brevity. According to the example embodiment, the reduced timeout value is estimated based on a total processing delay and a total network latency.

According to an example embodiment, the estimation module 405 estimates the network latency and the processing delay for each of the aggregators based on the details of the connection architecture. Accordingly, consider that the base timeout (x) for the OPC UA client is set at 60 seconds. Further, each aggregator introduces a specific delay as they process and forward requests. Additionally, there are inherent network latency and processing times that are required to be considered based on the deployment levels and other aspects of the connection architecture. Further, consider that the estimation module 405 estimates the following:
Primary aggregator A 203 introduces a processing delay of 2 seconds.
Secondary Aggregator B 205 introduces a processing delay of 3 seconds.
Secondary Aggregator C 205 introduces a processing delay of 4 seconds.
The round-trip latency between the client 201 and the primary aggregator A 203 adds 5 seconds.
The round-trip latency between each aggregator adds an additional 2 seconds

Thus, the estimation module 405 computes the total processing delay based on the below expression (2).

$$Total processing delay = ( 2 + 3 + 4 ) = 9 seconds \qquad ( 2 )$$

Further, the estimation module 405 computes the total network latency based on:
Network latency from the client 201 to the primary aggregator 203 is 5 seconds
Between aggregators (i.e. transition from A to B and B to C)=2+2=4 seconds
Total Network Latency=(5+4=9) seconds

According to an embodiment, the estimation module 405 estimates the total time required to handle the bulk request while considering the processing delays and the network latencies based on the expression (3).

$$Total time requirement for processing = Total Processing Delay + Total Network Latency = 9 + 9 = 18 seconds \qquad ( 3 )$$

According to some embodiment, the estimation module 207 may consider the total time requirement as a basis for estimating the reduced timeout value. According to some embodiments, the estimation module 207 can set the reduced timeout value such that the modified timeout value at each aggregator should be obtained in more than 18 seconds ensuring that requests can be processed effectively without timing out prematurely.

According to an embodiment, the primary aggregator 203 after receiving complete data in response to the bulk data request, determines the amount of data received, from the direct data sources 207 and the indirect data sources 209, corresponding to the bulk data request. Accordingly, if the primary aggregator 203 determines that the amount of data received is less than the requested data in the bulk data request, the primary aggregator 203 requests the secondary aggregators 205 to send a continuation point from the end data sources. In an embodiment, the continuation point is used to manage the flow of large data requests and responses. According to an embodiment, the continuation point is used by the end data source (like the historian) to facilitate large data requests efficiently. If the bulk data request for data is too large to be processed in one go (for example, fetching extensive historical data for many nodes), the data source can return a continuation point instead of the entire dataset. This allows the client 201 to make subsequent requests starting from that point.

For example, the timeout can occur when the bulk data request takes longer than the set timeout limit to receive a response. If the OPC UA aggregator 205 doesn't receive a timely response from the end data source (for e.g. historian), then the end data sources can send the continuation point. Consider a monitoring application that retrieves temperature data for equipment from a historian. Consider that the client 201 requests the bulk data request comprising historical data for the past month for 1,000 temperature sensors along with a specified base timeout value. In an embodiment, the historian processes this bulk data request. However, due to the large volume of data, the historian cannot send the entire dataset in one response due to time constraints or internal limits. In such a scenario, the historian can process the first batch of data, for example, the data for the first 500 sensors, and send it to the client. Further, in an embodiment, along with this data, the historian further includes a continuation point. An example of the response is shown in Table 1 below.

```
TABLE 1
    {
      “data”: [
```

| | |
|---|---|
| {“sensor_id”: “sensor_1”, | “timestamp”: “2024-11-01T00:00:00Z”, |

“temperature”: 22.5},

| | |
|---|---|
| {“sensor_id”: “sensor_2”, | “timestamp”: “2024-11-01T00:00:00Z”, |

```
    “temperature”: 23.0},
          ...........
```

| | |
|---|---|
| {“sensor_id”: “sensor_500”, | “timestamp”: “2024-11-01T00:00:00Z”, |

```
    “temperature”: 21.0},
      ];
  “continuationPoint”: “CP_200123456”
}
```

In an embodiment, the continuation point indicates the continuation point from which the amount of the data that is remaining is to be sent by each of the one or more direct data sources and the one or more indirect data sources in a subsequent bulk data request. According to the example scenario, the determination module 403 receives the continuation point for example the continuationPoint: “CP_200123456” which indicates the aggregators 205 to continue from, when the client requests for the data in the next request. The primary aggregator 203 provides the continuation point to the client so that in the next bulk data request, the primary aggregator 203 forwards the next subsequent request comprising the continuation point. Table 2 depicts an example of a subsequent bulk data request for fetching the remaining data based on the continuation point.

TABLE 2

{
“continuationPoint”: “CP_200123456”
}

According to an embodiment, the historian processes the new request, starting from the point indicated by the continuation point, and returns the next batch of data (e.g., for sensors 501 to 1000). Table 3 illustrates the response for receiving the next batch of data based on the continuation point.

```
TABLE 3
    {
      “data”: [
```

| | |
|---|---|
| {“sensor_id”: “sensor_501”, “timestamp”: | “2024-11-01T00:00:00Z”, |

“temperature”: 22.5},

| | |
|---|---|
| {“sensor_id”: “sensor_502”, “timestamp” | “2024-11-01T00:00:00Z”, |

```
    “temperature”: 23.0},
          ...........
```

| | |
|---|---|
| {“sensor_id”: “sensor_100”, “timestamp”: | “2024-11-01T00:00:00Z”, |

```
    “temperature”: 21.0},
      ];
  “continuationPoint”: “null”
}
```

According to an embodiment, the client 201 further stores the data over the cloud database 213. The data that is received in response to the bulk data request is further utilized for various purposes.

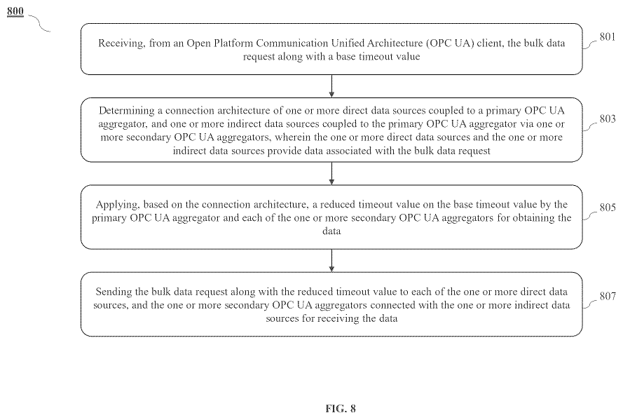

FIG. 8 illustrates a method flow for managing timeouts for a bulk data request, according to an embodiment of the present disclosure. According to an embodiment, the method 800 is performed by the OPC UA primary aggregator 203. A detailed explanation of the same is provided through the FIGS. 2 to 7. Therefore, a detailed explanation of the same is being omitted here.

According to an embodiment, the receiving module 401 of the OPC UA client 201, at steps 801, receives, from the OPC UA client 201, the bulk data request along with the base timeout value.

Further, the determination module 403 of the OPC UA client 201, at step 803 determines the connection architecture of one or more direct data sources 207 coupled to the primary OPC UA aggregator 203, and one or more indirect data sources 209 coupled to the primary OPC UA aggregator 203 via one or more secondary OPC UA aggregators 205. In an embodiment, the one or more direct data sources 207 and the one or more indirect data sources 209 provide the data associated with the bulk data request. In particular, the determination module 403 determines the connection architecture that comprises determining at least one of a number of direct data sources 207, a number of indirect data sources 209, and a number of secondary OPC UA aggregators 205 required in providing the data and determining the deployment level of the one or more direct data sources 207, the one or more indirect data sources 209, and the one or more secondary OPC UA aggregators 205.

Further, the estimation module 405, at step 805, based on the connection architecture, applies the reduced timeout value on the base timeout value by the primary OPC UA aggregator 203 and each of the one or more secondary OPC UA aggregators 205 for obtaining the data. According to an exemplary embodiment, the estimation module 405 may utilize ML models, an iterative method, or an optimization method for estimating the reduced timeout value. A detailed explanation of the same is provided through FIGS. 5-7. According to an embodiment, the estimation module 405 applies the reduced timeout value on the base timeout value by decreasing the reduced timeout value from the base timeout value to obtain the modified timeout value.

According to an embodiment, the estimation module 405 determines whether the data associated with the bulk data request can be received within the modified timeout value based on the connection architecture. Accordingly, based on the determination that the data associated with the bulk data request cannot be received within the modified timeout value, the estimation module 405 varying the reduced timeout value. In an embodiment, the reduced timeout value is applied on the base timeout value.

Further, the transmitting module 407, at step 807, sends the bulk data request along with the reduced timeout value to each of the one or more direct data sources, and the one or more secondary OPC UA aggregators connected with the one or more indirect data sources for receiving the data. In particular the transmitting module 407 forwards the bulk data request along with the reduced timeout value to at least one of the one or more direct data sources 207 and the one or more indirect data sources 209 via the one or more secondary OPC UA aggregators 209.

In an embodiment, the one or more secondary OPC UA aggregators 205 set the respective modified timeout value based on the reduced timeout value such that the respective modified timeout value is less than a previously received modified timeout value and the base timeout value.

According to an embodiment, the one or more secondary OPC UA aggregators 205 set a respective modified timeout value based on the reduced timeout value such that the respective modified timeout value is less than the previously received modified timeout value and the base timeout value. Accordingly, the primary aggregator 203 receives the data from the at least one of the one or more secondary OPC UA aggregators 205 and the one or more direct data sources 207 are within the modified timeout value.

According to a further embodiment, the primary OPC UA aggregator 203 further performs determining the amount of data received, from the one or more direct data sources 207 and the one or more indirect data sources 209, corresponding to the bulk data request. Further, the primary OPC UA aggregator 203 performs receiving the continuation point from at least one of the one or more direct data sources 207 and the one or more indirect data sources 209 based on the determination that the received amount of the data is less than the amount of the data requested corresponding to the bulk data request. In an embodiment, the continuation point indicates a point from which the amount of the data that is remaining is to be sent by each of the one or more direct data sources and the one or more indirect data sources in a subsequent bulk data request.

According to an embodiment, the primary OPC UA aggregator 203 further performs sending the data to the OPC UA client 201 for storing the data in a cloud database 213.

According to the disclosed methodology, in particular when dealing with a system consisting of multiple OPC UA aggregators in a daisy chain configuration, adjusting the timeout value prevents occurrence of the timeout. Thus, data loss between OPC UA aggregator and OPC UA client in a multi-connection network is effectively avoided.

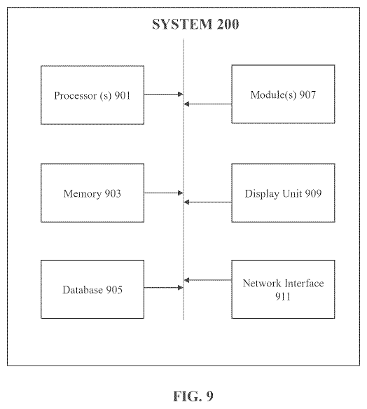

FIG. 9 illustrates a general block diagram of the system, according to an embodiment of the present disclosure. Further, the components of the system can be utilized in the client 201, the primary aggregator 203 and secondary aggregators 205.

In an example, the processor(s) 901 may be a single processing unit or a number of units, all of which could include multiple computing units. The processor(s) 901 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor(s) 901 is configured to fetch and execute computer-readable instructions and data stored in a memory 903.

The memory 903 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

In an example, the module(s), engine(s), and/or unit(s) 907 may include a program, a subroutine, a portion of a program, a software component or a hardware component capable of performing a stated task or function. As used herein, the module(s), engine(s), and/or unit(s) may be implemented on a hardware component such as a server independently of other modules, or a module can exist with other modules on the same server, or within the same program. The module(s), engine(s), and/or unit(s) 907 may be implemented on a hardware component such as processor one or more microprocessors, microcomputers, microcontrollers, digital signal processors, central processing units, state machines, logic circuitries, and/or any devices that manipulate signals based on operational instructions. The module(s), engine(s), and/or unit(s) 1102 when executed by the processor(s) 901 may be configured to perform any of the described functionalities. According to an embodiment, the module 907 includes one or more modules discussed above with reference to FIG. 4. In an alternate embodiment, the functions of the aforesaid modules may be performed by the processor(s) 901.

As a further example, the database 905 may be implemented with integrated hardware and software. The hardware may include a hardware disk controller with programmable search capabilities or a software system running on general-purpose hardware. Examples of databases are but are not limited to, in-memory databases, cloud databases, distributed databases, embedded databases, and the like. The database amongst other things, serves as a repository for storing data processed, received, and generated by one or more of the processors(s) 901, and the modules/engines/units.

The modules/engines/units 907 may be implemented with an AI module that may include a plurality of neural network layers. Examples of neural networks include, but are not limited to, a convolutional neural network (CNN), a deep neural network (DNN), a recurrent neural network (RNN), a Restricted Boltzmann Machine (RBM). The learning technique is a method for training a predetermined target device using a plurality of learning data to cause, allow, or control the target device to decide or prediction. Examples of the learning techniques include, but are not limited to, a supervised learning, unsupervised learning, a semi-supervised learning, or reinforcement learning. At least one of a plurality of CNN, DNN, RNN, RMB models and the like may be implemented to thereby achieve execution of the present subject matter's mechanism through an AI model. A function associated with the AI model may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or the artificial intelligence (AI) model stored in the non-volatile memory and the volatile memory. The predefined operating rule or artificial intelligence model is provided through training or learning.

As an example, the display unit 909 includes a computer monitor, a touch screen, an output device capable of displaying the graphics, and the like. The display unit 909 is configured to display visual output in desktops, laptops, and workstations. The display unit 909 may come in different sizes, resolutions, and types (such as LCD, LED, or OLED).

As a further example, the network interface 911 is configured to provide and establish communication with any electronic device via a public network, private network, or any wireless communication technology.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

A processor may include one or more general purpose processors (e.g., INTEL® or Advanced Micro Devices® (AMD) microprocessors) and/or one or more special purpose processors (e.g., digital signal processors or Xilinx® System on Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

A memory may include, but is no limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The terms operator, person, user, supervisor, and manager have been used interchangeably throughout the draft and corresponds to an individual working in an industry or directly or indirectly managing operations in the industrial environment.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

We claim:

1. A method for managing timeouts for a bulk data request, the method comprising:
receiving, from an Open Platform Communication Unified Architecture (OPC UA) client, the bulk data request along with a base timeout value;
determining a connection architecture of one or more direct data sources coupled to a primary OPC UA aggregator, and one or more indirect data sources coupled to the primary OPC UA aggregator via one or more secondary OPC UA aggregators, wherein the one or more direct data sources and the one or more indirect data sources provide data associated with the bulk data request;
applying, based on the connection architecture, a reduced timeout value on the base timeout value by the primary OPC UA aggregator and each of the one or more secondary OPC UA aggregators for obtaining the data; and
sending the bulk data request along with the reduced timeout value to each of the one or more direct data sources, and the one or more secondary OPC UA aggregators connected with the one or more indirect data sources for receiving the data.

2. The method of claim 1, wherein determining the connection architecture comprises:
determining at least one of a number of direct data sources, a number of indirect data sources, and a number of secondary OPC UA aggregators required in providing the data; and
determining a deployment level of the one or more direct data sources, the one or more indirect data sources, and the one or more secondary OPC UA aggregators.

3. The method of claim 1, wherein applying the reduced timeout value on the base timeout value comprises decreasing the reduced timeout value from the base timeout value to obtain a modified timeout value.

4. The method of claim 3, further comprising:
determining whether the data associated with the bulk data request can be received within the modified timeout value based on the connection architecture; and
varying the reduced timeout value based on the determination that the data associated with the bulk data request cannot be received within the modified timeout value, wherein the varied reduced timeout value is applied on the base timeout value.

5. The method of claim 1, wherein the bulk data request along with the reduced timeout value is forwarded to at least one of the one or more direct data sources and the one or more indirect data sources via the one or more secondary OPC UA aggregators.

6. The method of claim 3, wherein the one or more secondary OPC UA aggregators set a respective modified timeout value based on the reduced timeout value such that the respective modified timeout value is less than a previously received modified timeout value and the base timeout value.

7. The method of claim 3, wherein the data received from the at least one of the one or more secondary OPC UA aggregators and the one or more direct data sources are within the modified timeout value.

8. The method of claim 7, further comprising:
determining an amount of data received, from the one or more direct data sources and the one or more indirect data sources, corresponding to the bulk data request; and
receiving a continuation point from at least one of the one or more direct data sources and the one or more indirect data sources based on the determination that the received amount of the data is less than the amount of the data requested corresponding to the bulk data request.

9. The method of claim 8, wherein the continuation point indicates a point from which the amount of the data that is remaining is to be sent by each of the one or more direct data sources and the one or more indirect data sources in a subsequent bulk data request.

10. The method of claim 1, further comprising: sending the data to the OPC UA client for storing the data in a cloud database.

11. A system for managing timeouts for a bulk data request, wherein the system comprises:
a primary Open Platform Communication Unified Architecture (OPC UA) aggregator having one or more processors coupled with a memory,
one or more direct data sources coupled with the primary OPC UA aggregator;
one or more indirect data sources coupled with the primary OPC UA aggregator via one or more secondary OPC UA aggregators, and
an OPC UA client coupled with the primary OPC UA aggregator, wherein the one or more processors are configured to:
receive, from the OPC UA client, the bulk data request along with a base timeout value;
determine a connection architecture of the one or more direct data sources, and the one or more indirect data sources, wherein the one or more direct data sources and the one or more indirect data sources provide data associated with the bulk data request;
apply, based on the connection architecture, a reduced timeout value on the base timeout value by the primary OPC UA aggregator and each of the one or more secondary OPC UA aggregators for obtaining the data; and
send the bulk data request along with the reduced timeout value to each of the one or more direct data sources, and the one or more secondary OPC UA aggregators connected with the one or more indirect data sources for receiving the data.

12. The system of claim 11, wherein to determine the connection architecture, the one or more processors are further configured to:
determine at least one of a number of direct data sources, a number of indirect data sources, and a number of secondary OPC UA aggregators required in providing the data; and
determine a deployment level of the one or more direct data sources, the one or more indirect data sources, and the one or more secondary OPC UA aggregators.

13. The system of claim 11, wherein to apply the reduced timeout value on the base timeout value, the one or more processors are configured to decrease the reduced timeout value from the base timeout value to obtain a modified timeout value.

14. The system of claim 13, wherein the one or more processors are configured to:
determine whether the data associated with the bulk data request can be received within the modified timeout value based on the connection architecture; and
vary the reduced timeout value based on the determination that the data associated with the bulk data request cannot be received within the modified timeout value, wherein the varied reduced timeout value is applied on the base timeout value.

15. The system of claim 11, wherein the bulk data request along with the reduced timeout value is forwarded to at least one of the one or more direct data sources and the one or more indirect data sources via the one or more secondary OPC UA aggregators.

16. The system of claim 13, wherein the data received from at least one of the one or more secondary OPC UA aggregators and the one or more direct data sources are within the modified timeout value.

17. The system of claim 16, wherein the one or more processors are configured to:
determine an amount of data received, from the one or more direct data sources and the one or more indirect data sources, corresponding to the bulk data request; and
receive a continuation point from at least one of the one or more direct data sources and the one or more indirect data sources based on the determination that the received amount of the data is less than the amount of the data requested corresponding to the bulk data request.

18. The system of claim 17, wherein the continuation point indicates a point from which the amount of the data that is remaining is to be sent by each of the one or more direct data sources and the one or more indirect data sources in a subsequent bulk data request.

19. The system of claim 11, wherein the OPC UA client, the primary OPC UA aggregator, and the one or more OPC UA secondary aggregators are deployed in a multi-level connection architecture, wherein the OPC UA client is deployed at a first level of a network, wherein the primary OPC UA aggregator, the one or more secondary OPC UA aggregators, the one or more direct data sources, and the one or more indirect data sources are situated at a second level and a third level, respectively.

20. A non-transitory computer-readable storage medium storing program instructions for managing timeouts for a bulk data request, the program instructions, when executed, perform the steps of:
receiving, from an Open Platform Communication Unified Architecture (OPC UA) client, the bulk data request along with a base timeout value;
determining a connection architecture of one or more direct data sources coupled to a primary OPC UA aggregator, and one or more indirect data sources coupled to the primary OPC UA aggregator via one or more secondary OPC UA aggregators, wherein the one or more direct data sources and the one or more indirect data sources provides data associated with the bulk data request;
applying, based on the connection architecture, a reduced timeout value on the base timeout value by the primary OPC UA aggregator and each of the one or more secondary OPC UA aggregators for obtaining the data; and
sending the bulk data request along with the reduced timeout value to each of the one or more direct data sources, and the one or more secondary OPC UA aggregators connected with the one or more indirect data sources for receiving the data.
